(19) United States
(12) Patent Application Publication
(10) Pub. No.: US 2008/0227946 A1
(43) Pub. Date: Sep. 18, 2008

(54) Thermosetting Composition and Curing Method Thereof

(75) Inventors: Hirotoshi Kamata, Kanagawa (JP); Kazuya Kimura, Kanagawa (JP); Hiroshi Uchida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K.

(21) Appl. No.: 11/547,664

(22) PCT Filed: Apr. 5, 2005
(86) PCT No.: PCT/JP05/07000

§ 371 Date: Oct. 6, 2006

Related U.S. Application Data
(60) Provisional application No. 60/562,221, filed on Apr. 15, 2004.

(30) Foreign Application Priority Data
Apr. 6, 2004 (JP) 2004-111971

(51) Int. Cl. C08G 63/02

(52) U.S. Cl. 528/302

(57) ABSTRACT

The invention relates to a thermosetting composition comprising (A) a compound having at least one oxetanyl group in the molecule, (B) a compound having at least two carboxyl groups in the molecule, and (C) an imidazolium salt, curing method thereof and products cured thereby. Cured products prepared from the composition of the invention is excellent in electrical isolation, flexibility, adhesiveness and mechanical strength.

### CROSS-REFERENCE TO RELATED APPLICATIONS

This is an application filed pursuant to 35 U.S.C. Section 111(a) with claiming the benefit of U.S. provisional application Ser. No. 60/562,221 filed Apr. 15, 2004 under the provision of 35 U.S.C. 111(b), pursuant to 35 U.S.C. Section 119(e) (1).

### TECHNICAL FIELD

The present invention relates to a thermosetting composition excellent in adhesiveness, thermal resistance, chemical resistance and also particularly electrical isolation. The thermosetting composition of the invention is expectable to be utilized in the fields of electric isolation materials such as solder resists and interlayer insulating films, sealing materials for IC and VLSI, laminated sheets, and the like.

### BACKGROUND ART

An oxetane compound is a four-membered ether compound where the bond between carbon-oxygen is polarized and exhibits a high reactivity. The compound has high safety for the human body and excellent properties such as showing large polymerization rate in photo cationic polymerization and thermal cationic polymerization and being almost immune to influence of oxygen in an atmosphere, unlike an epoxy compound.

Recently, advances have been made in the studies on ring-opening reactions other than cationic polymerization. For example, there are disclosed a reaction of an oxetane compound with a polycarboxylic acid in JP-A-11-43540, a reaction of an oxetane compound with an acid anhydride in JP-A-11-315181, and a reaction of an oxetane compound with a thiol compound in JP-A-11-343346. In addition, there are exemplified reactions with an acyl halide compound and a phenol compound in Kogyo Zairyo, Vol. 49, No. 6, p 53-60 (2001) where a possibility of the construction of a new thermal curing system is predicted. Thus, expansion of its industrial use in the future is also expected.

### DISCLOSURE OF THE INVENTION

However, onium salts such as tetraphenylphosphonium bromide, tetra-n-butylphosphonium bromide, tetrabutylammonium bromide are used in the above precedent technologies and thermally cured products obtained by the techniques are problematic in view of electric insulation failure due to remaining phosphonium cations, ammonium cations, and halogen anions, which has been hindering application of the technologies into the field of electronic materials.

The present invention has been accomplished in consideration for such a situation, and an object of the invention is to provide a thermosetting composition exhibiting electric isolation, flexibility, adhesiveness and also mechanical strength in a cured product thereof.

As a result of extensive studies, the present inventors have found out that a cured product excellent in electric isolation can be obtained by using a specific imidazolium salt as a curing catalyst. Based on this finding, they have accomplished the invention.

Namely, the invention relates to the thermosetting compositions and curing methods thereof of 1 to 7 shown in the following.
1. A thermosetting composition comprising (A) a compound having at least one oxetanyl group in the molecule, (B) a compound having at least two carboxyl groups in the molecule, and (C) an imidazolium salt.
2. The thermosetting composition according to the above 1, wherein the compound (A) is a compound represented by the formula (6):

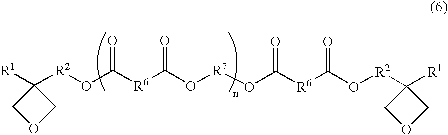

(wherein R¹ represents a hydrogen atom or an alkyl group having 1 to 6 carbon atoms which may be branched, R² represents an alkylene group having 1 to 6 carbon atoms which may be branched, R⁶ represents an alkylene group having up to 12 carbon atoms, an alkenylene group having up to 12 carbon atoms, a cycloalkylene group having up to 12 carbon atoms or an arylene group having up to 12 carbon atoms, R⁷ represents an alkylene group having up to 12 carbon atoms or a cycloalkylene group having up to 12 carbon atoms, and n represents an integer of 1 to 50) or a phenol novolak oxetane compound.
3. The thermosetting composition according to the above 1, wherein the imidazolium salt (C) is a salt of an imidazole compound and a compound having a carboxyl group.
4. The thermosetting composition according to the above 1, comprising 0.1 to 20 parts by mass of the imidazolium salt (C) based on 100 parts by mass as the sum total of the compound (A) and the compound (B).
5. The thermosetting composition according to the above 1, wherein the number of the carboxyl groups in the compound (B) is from 0.3 to 2 equivalents to the sum total number of the oxetanyl groups and the hydroxyl groups in the compound (A) and the hydroxyl groups formed in the polyaddition reaction between the oxetanyl group and the carboxyl group of the compound (B)
6. A curing method which comprises curing the thermosetting composition according to any one of the above 1 to 5 by heating.
7. A cured product obtainable by the curing method according to the above 6.

### DETAILED DESCRIPTION OF THE INVENTION

The following will describe the invention in detail.

### 1. (A) Compound Having at Least One Oxetanyl Group in the Molecule

The compound having at least one oxetanyl group in the molecule (hereinafter sometimes referred to as compound (A)) for use in the invention is a compound having one or more oxetanyl groups in one molecule and examples of such a compound include a compound represented by the formula (1)

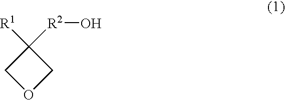

(wherein R¹ represents a hydrogen atom or an alkyl group having 1 to 6 carbon atoms which may be branched and R² represents an alkylene group having 1 to 6 carbon atoms which may be branched) and an etherified or esterified product thereof.

Specific examples of R¹ include a methyl group, an ethyl group, an n-propyl group, an n-butyl group, a sec-butyl group, a tert-butyl group, an n-pentyl group and an n-hexyl group. In view of the availability of raw materials, a methyl group and an ethyl group are particularly preferred among them.

Moreover, specific examples of R² include a methylene group, an ethylene group, a propylene group, a butylene group, a pentylene group and a hexylene group. In view of the availability of raw materials, a methylene group and an ethylene group are particularly preferred among them.

Specific examples of the compound represented by the formula (1) include 3-hydroxymethyloxetane, 3-methyl-3-hydroxymethyloxetane and 3-ethyl-3-hydroxymethyloxetane.

The etherified product of the compound represented by the formula (1) includes a compound represented by the formula (2)

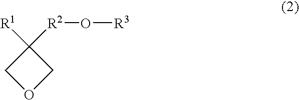

(wherein R¹ represents a hydrogen atom or an alkyl group having 1 to 6 carbon atoms which may be branched, R² represents an alkylene group having 1 to 6 carbon atoms which may be branched, and R³ represents an alkyl group having up to 12 carbon atoms, a cycloalkyl group having up to 12 carbon atoms, an aralkyl group having up to 12 carbon atoms or an aryl group having up to 12 carbon atoms).

Specific examples of R¹ and R² include those as mentioned above. For R³, specific examples of the alkyl group include a methyl group, an ethyl group, a propyl group, a butyl group, a pentyl group, a hexyl group, an octyl group, a decyl group, a dodecyl group and a 2-ethylhexyl group; specific examples of the cycloalkyl group include a cyclopentyl group, a cyclohexyl group, a cycloheptyl group, a dicyclopentanyl group and an isobornyl group; specific examples of the aralkyl group include a benzyl group and a phenethyl group; and specific examples of the aryl group include a phenyl group, a tolyl group, a mesityl group, an anisyl group and an naphthyl group.

An esterified product of the compound represented by the formula (1) is represented by the formula (3)

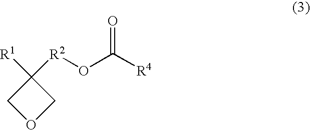

(wherein R¹ represents a hydrogen atom or an alkyl group having 1 to 6 carbon atoms which may be branched, R² represents an alkylene group having 1 to 6 carbon atoms which may be branched, and R⁴ represents an alkyl group having up to 12 carbon atoms, a cycloalkyl group having up to 12 carbon atoms or an aryl group having up to 12 carbon atoms).

Specific examples of R¹ and R² include those as mentioned above. For R⁴, specific examples of the alkyl group include a methyl group, an ethyl group, a propyl group, a butyl group, a pentyl group, a hexyl group, an octyl group, a decyl group, a dodecyl group and a 2-ethylhexyl group; specific examples of the cycloalkyl group include a cyclopentyl group and a cyclohexyl group; and specific examples of the aryl group include a phenyl group, a tolyl group, a mesityl group, an anisyl group and a naphthyl group.

Examples of compound having at least two oxetanyl groups in one molecule include an ether compound represented by the formula (4)

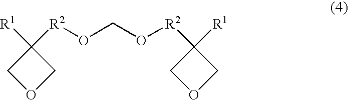

(wherein R¹ represents a hydrogen atom or an alkyl group having 1 to 6 carbon atoms which may be branched, R² represents an alkylene group having 1 to 6 carbon atoms which may be branched, and R⁵ represents an alkylene group having up to 12 carbon atoms, a cycloalkylene group having up to 12 carbon atoms or an arylene group having up to 12 carbon atoms), an ester compound represented by the formula (5)

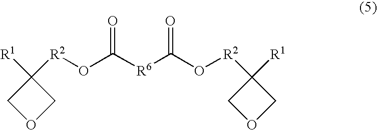

(wherein R¹ represents a hydrogen atom or an alkyl group having 1 to 6 carbon atoms which may be branched, R² represents an alkylene group having 1 to 6 carbon atoms which may be branched, and R⁶ represents an alkylene group having up to 12 carbon atoms, an alkenylene group having up to 12 carbon atoms, a cycloalkylene group having up to 12 carbon atoms or an arylene group having up to 12 carbon atoms), an ester compound represented by the formula (6)

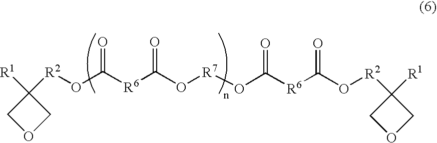

(wherein R¹ represents a hydrogen atom or an alkyl group having 1 to 6 carbon atoms which may be branched, R² represents an alkylene group having 1 to 6 carbon atoms which may be branched, R⁶ represents an alkylene group having up to 12 carbon atoms, an alkenylene group having up to 12 carbon atoms, a cycloalkylene group having up to 12 carbon atoms or an arylene group having up to 12 carbon atoms, R⁷ represents an alkylene group having up to 12 carbon atoms or a cycloalkylene group having up to 12 carbon atoms, and n represents an integer of 1 to 50), and a urethane compound represented by the formula (7)

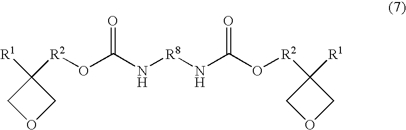

(wherein R¹ represents a hydrogen atom or an alkyl group having 1 to 6 carbon atoms which may be branched, R² represents an alkylene group having 1 to 6 carbon atoms which may be branched, and R⁸ represents an alkylene group having up to 12 carbon atoms, a cycloalkylene group having up to 12 carbon atoms, an arylene group having up to 12 carbon atoms or a group represented by the following formulae (8) to (15))

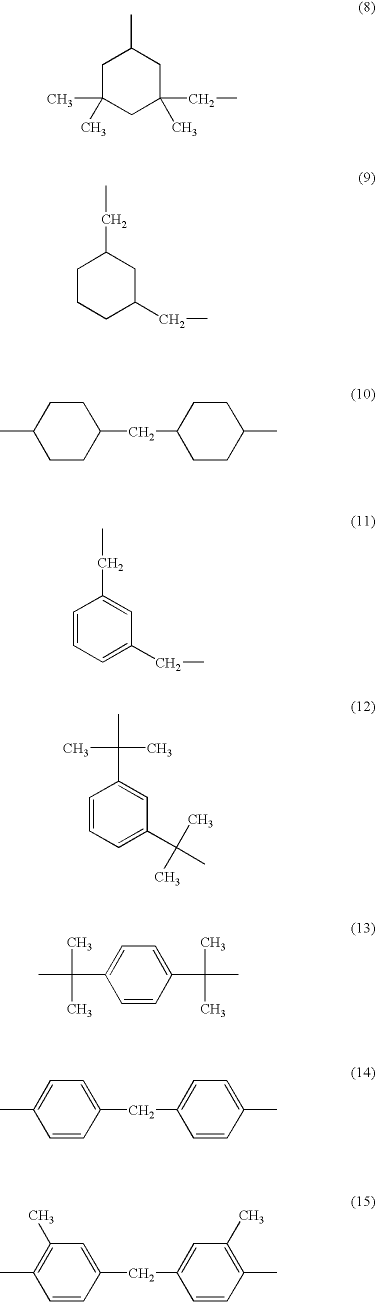

For R⁵, specific examples of the alkylene group include an ethylene group, a trimethylene group, a propylene group, a tetramethylene group, a 1,2-butylene group, a 1,3-butylene group, a 2,3-butylene group, a pentamethylene group, a 2,2-dimethylpropylene group and a hexamethylene group, an octamethylene group and a dodecamethylene group; specific examples of the cycloalkylene group include a 1,2-cyclopentylene group, a 1,2-cyclohexylene group and a 1,4-cyclohexylene group; and specific examples of the arylene group include a 1,4-phenylene group, a 1,3-phenylene group, a 1,2-phenylene group, a 2-methyl-1,4-phenylene group, a 4-methyl-1,3-phenylene group, a 6-methyl-1,3-phenylene group, a 4-methyl-1,2-phenylene group, a 2,6-naphthylene group and 1,4-naphthylene group.

For R⁶, specific examples of the alkylene group include an ethylene group, a trimethylene group, a tetramethylene group, a pentamethylene group, a hexamethylene group, an octamethylene group and a dodecamethylene group; specific examples of the alkenylene group include a vinylene group and a propenylene group; specific examples of the cycloalkylene group include a 1,2-cyclopentylene group, a 1,2-cyclohexylene group, a 1,3-cyclohexylene group, a 1,4-cyclohexylene group and a methyl-1,2-cyclohexylene group; and specific examples of the arylene group include a 1,4-phenylene group, a 1,3-phenylene group, a 1,2-phenylene group, a 2-methyl-1,4-phenylene group, a 4-methyl-1,3-phenylene group, a 6-methyl-1,3-phenylene group, a 4-methyl-1,2-phenylene group, a 1,4-naphthylene group and a 2,6-naphthylene group.

For R⁷, specific examples of the alkylene group include an ethylene group, a trimethylene group, a propylene group, a tetramethylene group, a 1,2-butylene group, a 1,3-butylene group, a 2,3-butylene group, a pentamethylene group, a 2,2-dimethylpropylene group, a hexamethylene group, an octamethylene group, a nonamethylene group and a dodecamethylene group; and specific examples of the cycloalkylene group include a 1,2-cyclopentylene group, a 1,2-cyclohexylene group and a 1,4-cyclohexylene group.

For R⁸, specific examples of the alkylene group include an ethylene group, a trimethylene group, a tetramethylene group, a pentamethylene group, a hexamethylene group, an octamethylene group and a dodecamethylene group; specific examples of the cycloalkylene group include a 1,2-cyclohexylene group, a 1,3-cyclohexylene group and a 1,4-cyclohexylene group; and specific examples of the arylene group include a 1,4-phenylene group, a 1,3-phenylene group, a 1,2-phenylene group, a 2-methyl-1,4-phenylene group, a 3-methyl-1,4-phenylene group, a 4-methyl-1,3-phenylene group, a 6-methyl-1,3-phenylene group, a 3-methyl-1,2-phenylene group, a 1,4-naphthylene group, a 1,5-naphthylene group and a 2,6-naphthylene group.

Moreover, examples of compound having three or more oxetanyl groups in one molecule includes compounds derived from polyhydric alcohols such as glycerin, trimethylolethane, trimethylolpropane, pentaerythritol and dipentaerythritol and specifically, such a compound can be represented by the formula (16):

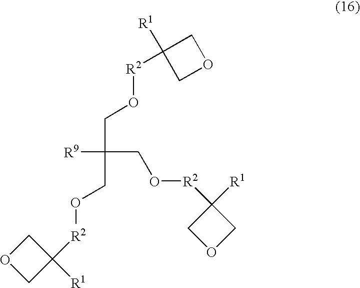

(wherein R¹ represents a hydrogen atom or an alkyl group having 1 to 6 carbon atoms which may be branched, R² represents an alkylene group having 1 to 6 carbon atoms which may be branched, and R⁹ represents a hydrogen atom or an alkyl group having 1 to 6 carbon atoms) and the formula (17)

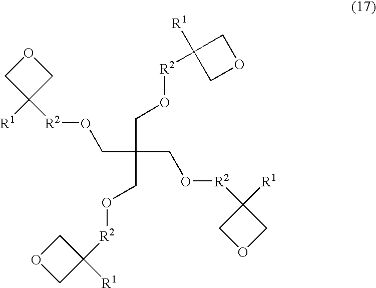

(wherein R¹ represents a hydrogen atom or an alkyl group having 1 to 6 carbon atoms which may be branched and R² represents an alkylene group having 1 to 6 carbon atoms which may be branched).

Preferred examples of R⁹ include a methyl group, an ethyl group, a propyl group, a butyl group and a hexyl group.

The other examples of compound (A) include an oxetane compound having a novolak skeleton as described in JP-A-2000-336133, a homopolymer of a compound having a (meth)acryloyl group and an oxetanyl group in one molecule as represented by the formula (18)

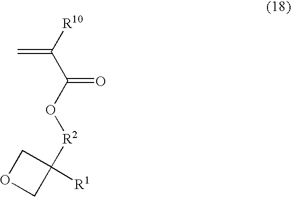

(wherein R¹ represents a hydrogen atom or an alkyl group having 1 to 6 carbon atoms which may be branched, R² represents an alkylene group having 1 to 6 carbon atoms which may be branched, and R¹⁰ represents a hydrogen atom or a methyl group), and a copolymer of the compound represented by the formula (18) and a compound not having an oxetanyl group but having an ethylenic unsatulated group.

As the compound (A) of the invention, the above compounds can be used solely or as a mixture of two or more of them.

The compounds represented by formulae (1) to (7), (16) and (17) mentioned as examples of the compound (A) having at least one oxetanyl group in the molecule can be synthesized by known methods. For example, among ester compounds represented by formula (6), a compound wherein R¹ represents an ethyl group, R² represents a methylene group, R⁶ represents a phenylene-1,4-diyl group and R⁷ represents a n-hexylene group can be synthesized by the method described later in Synthesis Example 1, and a compound wherein R⁷ represents a cyclohexane-1,4-dimethylene group can be synthesized by the method described later in Synthesis Example 2.

### 2. (B) Compound Having at Least Two Carboxyl Groups in the Molecule

The compound (B) having at least two carboxyl groups in the molecule (hereinafter sometimes referred to as “compound (B)”) is a compound having two or more carboxyl groups in the molecule and examples of the compound include linear aliphatic saturated dicarboxylic acids having 2 to 30 carbon atoms, such as oxalic acid, malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, octadecanedioic acid, nonadecanedioic acid, and icosanedioc acid; branched aliphatic saturated dicarboxylic acids having 3 to 30 carbon atoms, such as methylmalonic acid, ethylmalonic acid, n-propylmalonic acid, n-butylmalonic acid, methylsuccinic acid, ethylsuccinic acid and 1,1,3,5-tetramethyloctylsuccinic acid; linear or branched aliphatic unsaturated dicarboxylic acids such as maleic acid, fumaric acid, citraconic acid, γ-methylcitraconic acid, itaconic acid, and glutaconic acid; saturated or unsaturated alicyclic dicarboxylic acids such as hexahydrophthalic acid, hexahydroisophthalic acid, hexahydroterephthalic acid, methylhexahydrophthalic acid, methylhexahydroisophthalic acid, methylhexahydroterephthalic acid, tetrahydrophthalic acid, cyclohexene-1,2-dicaroxylic acid, cyclohexene-1,6-dicaroxylic acid, cyclohexene-3,4-dicaroxylic acid, endomethylenetetrahydrophthalic acid, endo-cis-bicyclo[2.2.1]hept-ene-2,3-dicarboxylic acid (trade name: Nadic acid), methyl-endo-cis-bicyclo[2.2.1]hept-ene-2,3-dicarboxylic acid (trade name: Methylnadic acid) and chlorendic acid; and aromatic dicarboxylic acids such as phthalic acid, terephthalic acid, isophthalic acid, 3-methylphthalic acid, 3-ethylphthalic acid, 3-n-propylphthalic acid, 3-isopropylphthalic acid, 3-n-butylphthalic acid, 3-isobutylphthalic acid, 3-sec-butylphthalic acid, 3-tert-butylphthalic acid, 4-methylphthalic acid, 4-ethylphthalic acid, 4-n-propylphthalic acid, 4-isopropylphthalic acid, 4-n-butylphthalic acid, 4-isobutylphthalic acid, 4-sec-butylphthalic acid, 4-tert-butylphthalic acid, 2-methylisophthalic acid, 2-ethylisophthalic acid, 2-n-propylisophthalic acid, 2-isopropylisophthalic acid, 2-n-butylisophthalic acid, 2-isobutylisophthalic acid, 2-sec-butylisophthalic acid, 2-tert-butylisophthalic acid, 4-methylisophthalic acid, 4-ethylisophthalic acid, 4-n-propylisophthalic acid, 4-isopropylisophthalic acid, 4-n-butylisophthalic acid, 4-isobutylisophthalic acid, 4-sec-butylisophthalic acid, 4-tert-butylisophthalic acid, 5-methylisophthalic acid, 5-ethylisophthalic acid, 5-n-propylisophthalic acid, 5-isopropylisophthalic acid, 5-n-butylisophthalic acid, 5-isobutylisophthalic acid, 5-sec-butylisophthalic acid, 5-tert-butylisophthalic acid, methylterephthalic acid, ethylterephthalic acid, n-propylterephthalic acid, isopropylterephthalic acid, n-butylterephthalic acid, isobutylterephthalic acid, sec-butylterephthalic acid, tert-butylterephthalic acid, naphthalene-1,2-dicarboxylic acid, naphthalene-1,3-dicarboxylic acid, naphthalene-1,4-dicarboxylic acid, naphthalene-1,6-dicarboxylic acid, naphthalene-2,6-dicarboxylic acid, anthracene-1,3-dicarboxylic acid, anthracene-1,4-dicarboxylic acid, anthracene-1,5-dicarboxylic acid and anthracene-9,10-dicarboxylic acid.

Examples of the compound having three or more carboxyl groups in the molecule include aliphatic tricarboxylic acids such as citric acid, isocitric acid and anicotic acid; aromatic tricarboxylic acids such as trimellitic acid and trimesic acid; aliphatic tetracarboxylic acids such as 1,2,4-butanetricarboxylic acid and 1,2,3,4-butantetracarboxylic acid; and aromatic tetracarboxylic acids such as pyromellitic acid and benzophenonetetracarboxylic acid.

Other than those mentioned above, a resin having carboxyl groups obtained by adding a polybasic acid anhydride to a novolak-type epoxy vinyl ester resin as described in JP-B-1-54390 (U.S. Pat. No. 5,009,982), a urethane(meth)acrylate resin having carboxyl groups as described in JP-A-11-35657, an acrylic copolymer having carboxyl groups at the side chains as described in JP-A-10-253815 and the like can be used as compound (B).

As the compound (B) of the invention, the above compounds can be used solely or as a mixture of two or more of them.

### 3. (C) Imidazolium Salt

The imidazolium salt (C) (hereinafter sometimes referred to as “compound (C)”) is a salt compound obtained by neutralizing an imidazole compound with a brφnsted acid and it functions as a curing catalyst for the addition reaction of an oxetanyl group with a carboxyl group. In particular, an imidazolium salt as a salt of an imidazole compound with a carboxylic acid, which causes no reduction in electric insulation property, is preferred.

Specific examples of the imidazole compound include imidazole, 2-methylimidazole, 1,2-dimethylimidamzole, 2-ethyl-4-methylimidazole, 2-phenylimidazole, 2-undecylimidazole, 2-heptadecylimidazole, 1-benzyl-2-methylimidazole, 1-benzyl-2-phenylimidazole, 2-phenyl-4-methylimidazole, 1-cyanoethyl-2-methylimidazole, 1-cyanoethyl-2-phenylimidazole, 1-cyanoethyl-2-ethyl-4-methylimidazole, 1-aminoethyl-2-methylimidazole, 1-(cyanoethylaminoethyl)-2-methylimidazole, 1-cyanoethyl-2-undecylimidazole, 2-phenyl-4-methyl-5-hydroxymethylimidazole, 2-phenyl-4,5-dihydroxymethylimidazole, N,N′-bis(2-methyl-1-imidazolylethyl)urea and N,N′-bis(2-methyl-1-imidazolylethyl)adipamide.

As a preferred brφnsted acid forming a salt with an imidazole compound, a compound having a carboxyl group may be mentioned and a compound having one carboxyl groups in one molecule and a compound having two or more carboxyl groups in the molecule can be exemplified.

Examples of the compound having one carboxyl group in one molecule include aliphatic carboxylic acids such as acetic acid, propionic acid, butyric acid, isobutyric acid, octylic acid, acrylic acid, crotonic acid, lactic acid, 2-methyllactic acid, and pyruvic acid; alicyclic carboxylic acids such as cyclohexanecarboxylic acid; aromatic carboxylic acids such as benzoic acid, salicylic acid, p-hydroxybenzoic acid, p-t-butylbenzoic acid, and p-methoxyphenylacetic acid.

Moreover, specific examples of the compound having two or more carboxyl groups in one molecule include the above compound (B).

The brφnsted acid other than carboxylic acid includes sulfonic acids such as methanesulfonic acid, p-toluenesulfonic acid, 1-naphthalenesulfonic acid, 2-naphthalenesulfonic acid, and trifluoromethanesulfonic acid; and inorganic acids such as phosphoric acid, perchloric acid, tetrafluoroboric acid, and hexafluorophosphoric acid.

Preferred examples of the imidazolium salt include 1-cyanoethyl-2-methylimidazolium trimellitate, 1-cyanoethyl-2-phenylimidazolium trimellitate, 1-cyanoethyl-2-ethyl-4-methylimidazolium trimellitate, and 1-cyanoethyl-2-undecylimidazolium trimellitate, for the low melting point and low volatility when heated.

The mixing ratio of the compound (C) in the thermosetting composition of the present invention is preferably from 0.1 to 20 parts by mass, more preferably from 0.5 to 10 parts by mass based on 100 parts by mass as the sum total of the compound (A) and the compound (B). When the mixing ratio is less than 0.1 part by mass, curability is decreased and a cured product having a sufficient strength cannot be obtained. On the other hand, when the ratio exceeds 20 parts by mass, since the imidazolium moiety of the compound (C) is not incorporated in the matrix of the cured product as a three dimensional crosslinking component, the strength of the cured product decreases and hence the case is not preferred.

The thermosetting resin composition of the present invention is obtained by dissolving or dispersing the above compound (A), compound (B) and compound (C) using a mixer, for example, a disperser, a kneader, a three-roll mill or a beads mill. At that time, a solvent inert to the oxetanyl group and carboxyl group may be used.

Examples of usable organic solvents include toluene, xylene, ethylbenzene, nitrobenzene, cyclohexane, isophorone, diethylene glycol dimethyl ether, ethylene glycol diethyl ether, propylene glycol methyl ether acetate, propylene glycol ethyl ether acetate, dipropylene glycol methyl ether acetate, diethylene glycol ethyl ether acetate, methyl methoxypropionate, ethyl methoxypropionate, methyl ethoxypropionate, ethyl ethoxypropionate, ethyl acetate, n-butyl acetate, isoamyl acetate, ethyl lactate, acetone, methyl ethyl ketone, cyclohexanone, N,N-dimethylformamide, N,N-dimethylacetamide, N-methylpyrrolidone, γ-butyrolactone, dimethyl sulfoxide, chloroform and methylene chloride.

The thermosetting composition of the invention can be transformed into a cured product by heating through a crosslinking reaction. The crosslinking reaction is achieved by process of polyaddition reaction of the above compound (A) with the compound (B) and polycondensation reaction of the hydroxyl group originally present in the compound (A) and/or the hydroxyl group formed in the above polyaddition reaction with the compound (B). With regard to the stoichiometric quantity of each functional group required for sufficient curing, the number of the carboxyl group in the compound (B) is preferably from 0.3 to 2 equivalents, more preferably from 0.5 to 1.5 equivalents to the sum total number of oxetanyl groups and hydroxyl groups originally contained in compound (A) (in some cases, no hydroxyl group is contained in compound (A)) and hydroxyl groups formed in the polyaddition reaction of the oxetanyl group with the carboxyl group of the compound (B) (the conversion rate of the compound (A) with the oxetanyl group in the compound (B) is presumed to be 100%). When the carboxyl group of the compound (B) is less than 0.3 equivalent, the above polyaddition reaction and polycondensation reaction do not proceed sufficiently and the molecular weight of the cured product does not increase sufficiently, so that the properties of the resulting cured product may be lowered. On the other hand, when it exceeds 2 equivalents, a large amount of the compound (B) may remain unreacted in the resulting cured product, which is unpreferable.

The thermosetting composition of the present invention can be cured by dissolving or dispersing it in a solvent which is not reactive to the above compound (A), compound (B) and compound (C) and subsequently drying the solvent, followed by further heating.

Moreover, the thermosetting composition of the present invention may be mixed with other thermosetting resins within the range where the effect of the invention is not impaired. Examples of such a thermosetting resin to be mixed with the thermosetting composition of the present invention include epoxy resins, phenol resins, vinyl ester resins, allyl ester resins, polyester resins, urethane resins, silicone resins, acrylic resins, melamine derivatives (e.g., hexamethoxymelamine, hexabutoxylated melamine and condensed hexamethoxy melamine), urea compounds (e.g., dimethylolurea), bisphenol compounds (e.g., tetramethylol-bisphenol A) and oxazoline compounds. These thermosetting resins can be used solely or as a mixture of two or more of them.

Furthermore, the thermosetting composition of the present invention may be mixed with various known additives, for example, inorganic fillers such as barium sulfate, talc, calcium carbonate, alumina, glass powder, quartz powder and silica; fiber reinforcing materials such as glass fiber, carbon fiber, and boron nitride fiber; colorants such as titanium oxide, zinc oxide, carbon black, iron black, organic pigments and organic dyes; antioxidants such as hindered phenol compounds, phosphorus compounds and hindered amine compounds; and UV absorbents such as benzotriazole compounds and benzophenone compounds.

In addition, according to intended usages, viscosity regulating agents, flame retardants, antibacterial agents, antifungal agents, age resisters, antistatic agents, plasticizers, lubricants, foaming agents and the like can be added and mixed.

### BEST MODE FOR CARRYING OUT THE INVENTION

The following will describe the invention with reference to Examples but the invention is by no means limited by these Examples.

### <Compound (A)>

### SYNTHESIS EXAMPLE 1

### Polyester Resin Having Two Oxetanyl Groups in One Molecule (OX-1)

In a 500 ml four-neck separable flask equipped with a distillation apparatus, 246.3 g (1.0 mol) of diallyl terephthalate (manufactured by Showa Denko K.K.), 116.2 g (1.0 mol) of 3-ethyl-3-hydroxymethyloxetane (manufactured by Ube Industries, Ltd.) and 0.25 g of dibutyltin oxide (manufactured by Tokyo Kasei Kogyo Co., Ltd.) were placed, and the whole was stirred at 175° C. under a nitrogen stream to effect the reaction for 7 hours while removing allyl alcohol formed in the reaction. Then, the pressure of inside of the reaction system was reduced and the reaction was continued for another 3 hours. The inside of the above reaction system was rendered normal pressure under a nitrogen atmosphere and cooled. Then, 59.09 g (0.50 mol) of 1,6-hexandiol (manufactured by Tokyo Kasei Kogyo Co., Ltd.) and 0.25 g of dibutyltin oxide (manufactured by Tokyo Kasei Kogyo Co., Ltd.) were added and the whole was stirred at 175° C. under a nitrogen stream to effect the reaction for 4 hours while removing allyl alcohol formed in the reaction. Thereafter, the pressure was reduced and the reaction was continued for another 4.5 hours. The above reaction system was rendered normal pressure under a nitrogen atmosphere and cooled. As a result, 312.9 g of a white resin was obtained.

### SYNTHESIS EXAMPLE 2

### Polyester Resin Having Two Oxetanyl Groups in One Molecule (OX-2)

In a 500 ml four-neck separable flask equipped with a distillation apparatus, 233.5 g (0.884 mol) of diallyl terephthalate (manufactured by Showa Denko K.K.), 102.7 g (0.884 mol) of 3-ethyl-3-hydroxymethyloxetane (manufactured by Ube Industries, Ltd.) and 0.23 g of dibutyltin oxide (manufactured by Tokyo Kasei Kogyo Co., Ltd.) were placed, and the whole was stirred at 180° C. under a nitrogen stream to effect the reaction for 7.5 hours while removing allyl alcohol formed in the reaction. Then, the pressure of inside of the reaction system was reduced and the reaction was continued for another 4.5 hours. The inside of the above reaction system was rendered normal pressure under a nitrogen atmosphere and cooled. Then, 63.73 g (0.442 mol) of 1,4-cyclohexanedimethanol (manufactured by Tokyo Kasei Kogyo Co., Ltd.) and 0.23 g of dibutyltin oxide (manufactured by Tokyo Kasei Kogyo Co., Ltd.) were added and the whole was stirred at 175° C. under a nitrogen stream to effect the reaction for 5.5 hours while removing allyl alcohol formed in the reaction. Thereafter, the pressure was reduced and the reaction was continued for another 14.5 hours. The above reaction system was rendered normal pressure under a nitrogen atmosphere and cooled. As a result, 298.4 g of a white resin was obtained.

### <Compound (B)>

### SYNTHESIS EXAMPLE 3

### Polyester Resin Having Carboxyl Group (CA-1)

Into a four-neck flask equipped with a thermometer, a condenser tube, a nitrogen inlet tube and a stirrer, 227 g of Epikote 828 (a bisphenol A-type epoxy resin, epoxy equivalent: 189, manufactured by Japan Epoxy Resins Co., Ltd.), 94 g (0.64 mol) of adipic acid (manufactured by Tokyo Kasei Kogyo Co., Ltd.), 5.0 g of triphenylphosphine (manufactured by Tokyo Kasei Kogyo Co., Ltd.), and 240 g of ethyl carbitol acetate (manufactured by Tokyo Kasei Kogyo Co., Ltd.), and the reaction was continued at 120° C. under a nitrogen atmosphere until the acid value reached a constant value. Furthermore, 120.1 g (1.2 mol) of succinic anhydride (manufactured by Tokyo Kasei Kogyo Co., Ltd.) was added and the reaction was continued at 120° C. The reaction was continued at 120° C. until disappearance of carbonyl group absorption by acid anhydride groups was observed by an infrared spectrophotometer (manufactured by JASCO Corporation, FT/IR 8000). The acid value of solid matter of the resulting polyester resin having carboxyl groups was 155 mg-KOH/g and the concentration of the solid matter was 65% by mass.

### EXAMPLES 1 to 5

After the respective components shown in Table 1 were mixed in a mixing ratio shown in Table 1, the whole was stirred for at least 3 hours on a magnetic stirrer to form a composition. Each of the resulting thermosetting compositions was applied on a glass fiber-reinforced epoxy resin basal plate by means of an applicator so as to be a film thickness of about 30 μm. After each coated plate was pre-dried at room temperature for 30 minutes, thermal curing was conducted under conditions of 170° C.×20 minutes, 40 minutes and 60 minutes.

Curability was evaluated according to a solvent-resistance test on each coated plate after thermal curing (chloroform was used in Examples 1 to 3 and Comparative Examples 1 and 2, and ethyl acetate was used in Example 4 and 5).

The solvent-resistance test was carried out as follows. Namely a few drops of the above solvent were applied on the coated plate of each Example or Comparative Example after thermal curing and the coating film was then softly rubbed 20 times back and forth with Kimwipe (product of Crecia Corporation). Then, the condition of the coated film after rubbing was evaluated according to the following five levels.
5: Neither defect nor change was observed on the coated film.
4: Some defects or changes were observed on the coated film.
3: Some scratches were observed on the coated film.
2: The coated film was partially dissolved.
1: The coated film was dissolved.

The results are shown in Table 1. From the results in Table 1, it was revealed that each Example was cured by heating.

### COMPARATIVE EXAMPLES 1 and 2

Thermosetting compositions were prepared in a similar manner to the Examples using the components and mixing amounts shown in Table 1 except that the composition of Comparative Example 1 contained no curing catalyst and that the composition of Comparative Example 2 used tetraphenylphosphonium bromide (manufactured by Tokyo Kasei Kogyo Co., Ltd.) as a curing catalyst.

Using each of the resulting compositions, a coated film was prepared in the same manner as in the Examples and then evaluated according to the solvent-resistance test. The results are shown in Table 1.

TABLE 1
Blending ratios of thermosetting compositions and heat-curability of compositions

| | Ex. 1 | Ex. 2 | Ex. 3 | Ex. 4 | Ex. 5 | Comp. 1 | Comp. 2 |
|---|---|---|---|---|---|---|---|
| Components (parts by mass) | | | | | | | |
| Compound having oxetanyl groups (A) | | | | | | | |
| OX-1 (Oxetanyl group equivalent weight: 3.27 meq./g) | 100.0 | 100.0 | — | — | — | 100.0 | 100.0 |
| OX-2 (Oxetanyl group equivalent weight: 2.97 meq./g) | — | — | 100.0 | — | — | — | — |
| PNOX-1009 *1 (Oxetanyl group equivalent weight: 5.00 meq./g) | — | — | — | 100.0 | 100.0 | — | — |
| Compound having carboxyl groups (B) | | | | | | | |
| Rikacid BT-W *2 (Carboxyl group equivalent weight: 17.2 meq./g) | 25.0 | 25.0 | 25.0 | — | — | 25.0 | 25.0 |
| CA-1 (solid carboxyl group equivalent weight: 2.78 meq./g) | — | — | — | 400.0 | 600.0 | — | — |
| Curing catalyst: imidazolium salt (C) | | | | | | | |
| 1-cyanoethyl-2-undecylimidazolium trimellitate *3 | 5.0 | — | 5.0 | 5.0 | 5.0 | — | — |
| 1-cyanoethyl-2-phenylimidazolium trimellitate *4 | — | 6.0 | — | — | — | — | — |
| Comparative curing catalyst | | | | | | | |
| Tetraphenyl phosphonium bromide *5 | — | — | — | — | — | — | 5.2 |
| Solvent | | | | | | | |
| Chloroform | 150 | 150 | 150 | — | — | 150 | 150 |
| Diethylene glycol monoethyl ether acetate | — | — | — | 50 | 70 | — | — |
| Functional group equivalent weight (meq.) in Composition | | | | | | | |
| Oxetanyl group | 327 | 327 | 297 | 500 | 500 | 327 | 327 |
| Hydroxyl group (including hydroxyl groups generated in the ring-opening | 327 | 327 | 297 | 500 | 500 | 327 | 327 |
| reaction of oxetanyl group) | | | | | | | |
| Carboxyl group | 430 | 430 | 430 | 723 | 1084 | 430 | 430 |
| Carboxyl group/(oxetanyl group + hydroxyl group) | 0.66 | 0.66 | 0.72 | 0.72 | 1.08 | 0.66 | 0.66 |
| Heat-curing property | | | | | | | |
| 170° C. × 20 minutes | 1 | 1 | 1 | 5 | 5 | 1 | 1 |
| 170° C. × 40 minutes | 5 | 5 | 5 | 5 | 5 | 1 | 5 |
| 170° C. × 60 minutes | 5 | 5 | 5 | 5 | 5 | 1 | 5 |

*1 phenol novolak oxetane average number of functional groups = 5 manufacture by TOAGOSEI CO, LTD.
*2 1,2,3,4-tetrabutane carboxylic acid manufactured by New Japan Chemical Co., Ltd.
*3 Product name C11Z-CNS manufactured by SHIKOKU CORP.
*4 Product name 2PZ-CNS manufactured by SHIKOKU CORP.
*5 manufactured by Tokyo Kasei Kogyo Co., Ltd.

### INDUSTRIAL APPLICABILITY

Since the thermosetting composition of the invention is excellent in thermal curability and also a cured product thereof is excellent in electrical isolation as well as is excellent in flexibility, adhesiveness, and mechanical strength, the composition is expected to be utilized in the fields of electric isolation materials such as solder resists and interlayer insulating films, sealing materials for IC and VLSI, laminated sheets, and the like where electric isolation is required.

1. A thermosetting composition comprising (A) a compound having at least one oxetanyl group in the molecule, (B) a compound having at least two carboxyl groups in the molecule, and (C) an imidazolium salt.

2. The thermosetting composition according to claim 1, wherein the compound (A) is a compound represented by the formula (6): 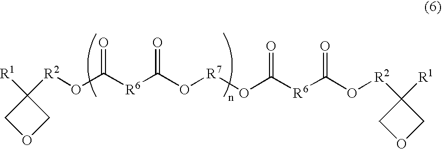
(wherein R¹ represents a hydrogen atom or an alkyl group having 1 to 6 carbon atoms which may be branched, R²represents an alkylene group having 1 to 6 carbon atoms which may be branched, R⁶ represents an alkylene group having up to 12 carbon atoms, an alkenylene group having up to 12 carbon atoms, a cycloalkylene group having up to 12 carbon atoms or an arylene group having up to 12 carbon atoms, R⁷ represents an alkylene group having up to 12 carbon atoms or a cycloalkylene group having up to 12 carbon atoms, and n represents an integer of 1 to 50)
or a phenol novolak oxetane compound.

3. The thermosetting composition according to claim 1, wherein the imidazolium salt (C) is a salt of an imidazole compound and a compound having a carboxyl group.

4. The thermosetting composition according to claim 1, comprising 0.1 to 20 parts by mass of the imidazolium salt (C) based on 100 parts by mass as the sum total of the compound (A) and the compound (B).

5. The thermosetting composition according to claim 1, wherein the number of the carboxyl groups in the compound (B) is from 0.3 to 2 equivalents to the sum total number of the oxetanyl groups and the hydroxyl groups in the compound (A) and the hydroxyl groups formed in the polyaddition reaction between the oxetanyl group and the carboxyl group of the compound (B).

6. A curing method which comprises curing the thermosetting composition according to claim 1 by heating.

7. A cured product obtainable by the curing method according to claim 6.

8. A curing method which comprises curing the thermosetting composition according to claim 2 by heating.

9. A curing method which comprises curing the thermosetting composition according to claim 3 by heating.

10. A curing method which comprises curing the thermosetting composition according to claim 4 by heating.

11. A curing method which comprises curing the thermosetting composition according to claim 5 by heating.

12. A cured product obtainable by the curing method according to claim 8.

13. A cured product obtainable by the curing method according to claim 9.

14. A cured product obtainable by the curing method according to claim 10.

15. A cured product obtainable by the curing method according to claim 11.
